(19) United States
(12) Patent Application Publication
(10) Pub. No.: US 2004/0227463 A1
(43) Pub. Date: Nov. 18, 2004

(54) FLAT PANEL DISPLAY HAVING CONDUCTORS MAGNETICALLY BONDED TO SUBSTRATE

(76) Inventor: Martin P. Lepselter, Summit, NJ (US)

Correspondence Address: DARBY & DARBY P.C., P. O. BOX 5257, NEW YORK, NY, 10150-5257, US

(21) Appl. No.: 10/249,896

(22) Filed: May 15, 2003

(51) Int. Cl. H01J 17/49

(52) U.S. Cl. 313/582; 313/584; 313/586

(57) ABSTRACT

An improved plasma display of the type formed on a single side of a first substrate has a substrate with magnetic or ferromagnetic properties and an insulating layer disposed on its surface. As an example, the display can comprise a steel substrate having a porcelain enamel coating. The porcelain enamel forms a thin, hard, transparent and smooth coating on the steel while not disturbing the magnetic properties of the first substrate. The magnetic properties of the first substrate serve to align and affix to the substrate crossing sets of conductors that define picture elements of the display, thus reducing the cost and time associated with accurately aligning the sets of conductors. The porcelain enamel coating prevents short circuits that would otherwise occur between the crossing conductors and the supporting substrate.

### BACKGROUND OF INVENTION

This invention relates to a flat-panel display structure and a method for making the same and, in particular, to a gas discharge display formed on a substrate that includes magnetic or ferromagnetic materials therein.

Plasma based flat-panel displays have been known since the late 1960's, although the costs associated with their manufacture have kept these devices at bay from the masses. Broadly, such displays enclose a gas between opposed and crossed ribbons of conductors. The crossed conductors define a matrix of crosspoints which are essentially an array of gas discharge picture elements (“pixels”) or lamps that provide their own light. At any given pixel, the crossed, spaced conductors act like opposed electrode plates of a capacitor. A sufficiently large applied voltage causes the gas to break down locally into a plasma of electrons and ions and glow as it is excited by current. Paschen's Law relates the voltage at which a gas breaks down into a plasma, the so called spark or firing voltage, to the product of the pressure of the gas, p (in mm Hg), times the distance, d (in cm), between the electrodes. By scanning the conductors sequentially, a row at a time, with a voltage sufficient to cause the pixels to glow, and repeating the process at least sixty times per second, a steady image can be perceived by the human eye.

Alignment of the sets of conductors for forming a discharge space, wherein the gas is excited into plasma, is critical for ensuring that a uniform firing voltage can be utilized across the display. As a key aspect of the design of plasma displays, alignment of the sets of conductors can be costly and time consuming. This problem was addressed, in part, in U.S. Pat. No. 5,962,975 to Lepselter, which patent is hereby incorporated by reference. The construction described in that patent utilized magnetic fields that emanated from magnetic elements that were placed on small, individual features of the display, specifically, the conductors and their supportive posts for alignment of the sets of conductors. Such a design calls for complicated insulating measures to be taken to prevent electrical short circuits and requires precision placement of one set of conductors directly upon respective posts.

Therefore, what is needed and has not yet been disclosed is a cost efficient flat-panel display employing magnetic properties to permit ready attachment of conductors without the difficulties of the prior art. present invention addresses these and other needs.

### SUMMARY OF INVENTION

In accordance with one aspect of the invention, a plasma display comprises a first substrate, first and second sets of conductors disposed proximate the first substrate define an array of crosspoints each having a gas discharge space therebetween at the crosspoints. A projection between the first and second sets of conductors defines the gas discharge space. The substrate includes a material selected from the group of magnetic materials and ferromagnetic materials, and an insulating layer is disposed between the surface of the substrate and the conductors.

In accordance with further aspects of the invention, the projections can be integrally formed with either the substrate that supports the first and second sets of conductors or can be integal to one of the sets of conductors (e.g., the first set of conductors).

In a presently preferred form, the substrate is steel and the insulating layer is a porcelain enamel coating. In another preferred form, the plasma display includes a superstrate that supports an array of hollow chambers lined, at least in part, with a phosphor and/or a light reflector. The hollow chambers are preferably configured to draw plasma from between the first and second conductors (e.g., are electrically connected as anodes or cathodes, depending on the configuration of the rest of the panel) and into the hollow chamber that presents a comparatively increased surface area for improving the efficiency of the display as compared to a display constructed without the superstrate.

These and other aspects, features and advantages can be appreciated from the accompanying Drawings and Detailed Description of the Preferred Embodiments.

### BRIEF DESCRIPTION OF DRAWINGS

FIG. 1 is a diagram for explaining Paschen's law;

FIG. 2 is a top plan view of a portion of a plasma display constructed according to one embodiment of the present invention;

FIG. 3 is a cross-sectional view of FIG. 2 along line 3—3, showing a second superstrate spaced from components on the first substrate, though the two strata can be in contact with one another. The use of a single substrate, previously taught by Lepselter, allows for the manufacture of very large displays. The substrate may be used to allow a superstrate to be bonded to it for precision alignment capability. This superstrate carries the phosphor-coated tubes to be described subsequently.

FIG. 3A is a top plan view of an alternative embodiment;

FIG. 4 is a perspective view of the conductor roll;

FIG. 5 is a cross-sectional view of the first substrate illustrating the projections integral with the first substrate;

FIG. 6 is a cross-sectional view of FIG. 5, further showing the projections integral with the first substrate; and

FIG. 7 is a block diagram illustrating a plasma display and associated control circuitry integrated on a chip.

### DETAILED DESCRIPTION

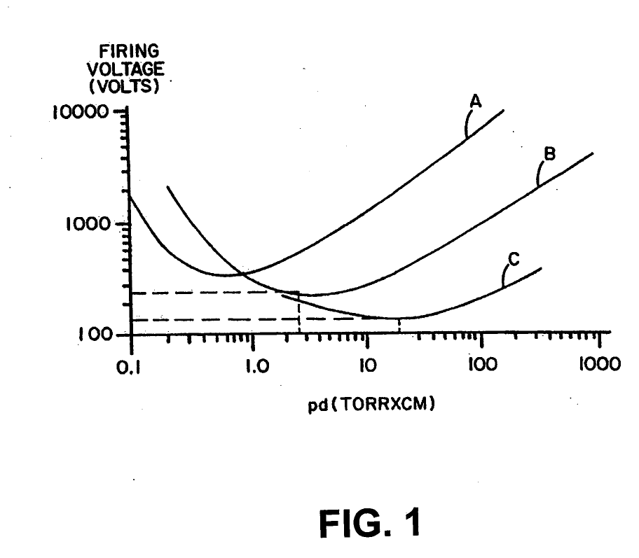

In accordance with Paschen's Law, every gas has a characteristic minimum firing voltage, Vmin, associated with a particular pressure-distance (“pd”) product, the product of the pressure of the gas, p (in mm Hg), times the distance d (in cm), between the electrodes (see FIG. 1). The firing voltage rises above this minimum at all other values of the pd product. In the region below curve A, B or C, a gas will not spark and there will be no initial discharge; however, an existing discharge can be sustained with voltages in this region. It is generally desirable to design a gas discharge display to operate at or near the Paschen minimum firing voltage in order to lower the needed voltages.

The overall size of a plasma display is largely dependent on the distance between the electrodes and the electrode size. The display size can thus be reduced by decreasing the distance between the electrodes and making them small enough to be densely arranged. Under Paschen's law, the distance may be reduced without increasing Vmin by increasing the pressure of the gas. For example, if the electrodes are positioned one micron apart, and a gas pressure of 7630 mm Hg is used, (10 atmospheres) a pd product of 0.763 mm Hg cm results. This value is substantially near the Vmin for gases such as Nitrogen with 5% Xenon which generate ultraviolet light when excited into a plasma.

The present invention provides a flat-panel gas discharge display which comprises a first set of conductors disposed on a first substrate and a second set of conductors which cross over the first set at a preselected distance therefrom. The preselected distance between the first and second sets of conductors is uniform throughout the display due to the placement of the second set of conductors relative to the same surface that supports the first set of conductors. Maintaining a uniform distance between the sets of conductors ensures that a uniform firing voltage can be applied throughout the display. An array of crosspoints is formed at each location where a conductor of the second set crosses over a conductor of the first set.

A gas is contained in the discharge space directly between the sets of conductors at each crosspoint. This gas will undergo light emissive discharge when a Paschen minimum firing voltage is applied across the discharge space at that crosspoint. To better achieve alignment, the substrate includes magnetic or ferromagnetic properties and an insulating layer disposed on its surface.

In a variation of the foregoing, the array of crosspoints can be associated with hollow tubes provided by a second superstrate. The crosspoints, discharge space, and hollow tubes define a chamber wherein a gas undergoes the light emissive discharge in response to excitation stimuli.

In a further variation, at least one of the sets of conductors may be provided with an aperture at each of the crosspoints to facilitate viewing the discharge.

The display of the preferred embodiment is formed on a steel substrate that has a porcelain enamel coating. Porcelain enamel (also referred to as vitreous enamel) is a specially formulated, highly durable glass that is permanently fused to metal under extremely high temperatures. The porcelain enamel coating is preferably a thin coating of glass applied as a powder or as a slurry on a panel such as a steel panel. The panel is subsequently fired in a furnace until the glass melts. The melted glass forms a thin, hard, transparent and smooth coating on the steel. The magnetic properties of the substrate are undisturbed and serve to align and affix the first and second sets of conductors that define the picture elements of the display, thus reducing the cost and time associated with accurately aligning the sets of conductors. The porcelain enamel coating prevents short circuits that would otherwise occur between the crossing conductors and the support substrate.

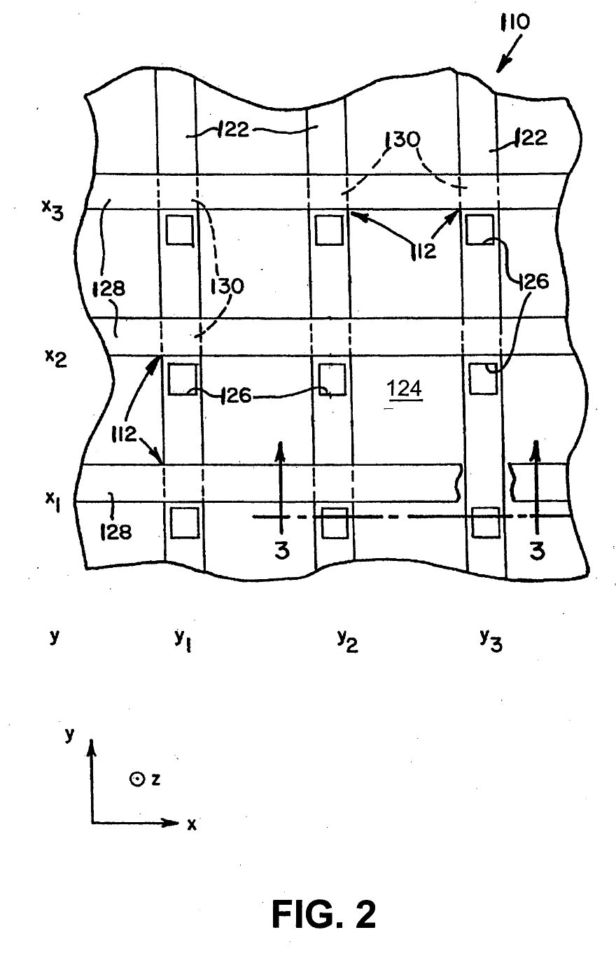

The plasma display will now be described with reference to FIGS. 2-6. 2 shows a top plan view portion of a display 110 comprising an array of plasma emitters 112 (alternatively referred to as pixels) according to the present invention. 3 is a cross-sectional view of two pixels of FIG. 2 taken along line 3—3.

The plasma display 110 is formed on a first substrate 120. In accordance with a salient aspect of the invention, the substrate 120 the preferred embodiment includes a material that is either magnetic or ferromagnetic in order to magnetically affix the conductors in position free of complex fabrication steps. The substrate 120 can include such material below its surface, or can be constituted entirely of such material. Such materials permit the conductors 122, 128 to be readily affixed to substrate 120. When such material is deposited onto the substrate, self-alignment of the conductors is possible as a result of the magnetic attraction between magnetic/magnetic or magnetic/ferromagnetic elements associated with the surfaces being brought together. Moreover, a lower bonding temperature for recrystallization of the materials to be joined may result due to the compressive force imparted by the magnetic field.

A corollary advantage of fabricating the display with a substrate having magnetic or ferromagnetic properties is that there is no need to bond the conductors on either side of every crosspoint 130 (FIG. 2) since the magnetic attraction and compressive forces between the elements will ensure that there is a reliable connection for structural integrity. This greatly simplifies production of large panels and permits a fast throughput and high yield of quality display panels.

An insulating layer 124 is provided on the surface of the first substrate 120. The insulating layer 124 is preferably made of a porcelain enamel that has been fused to the substrate 120.

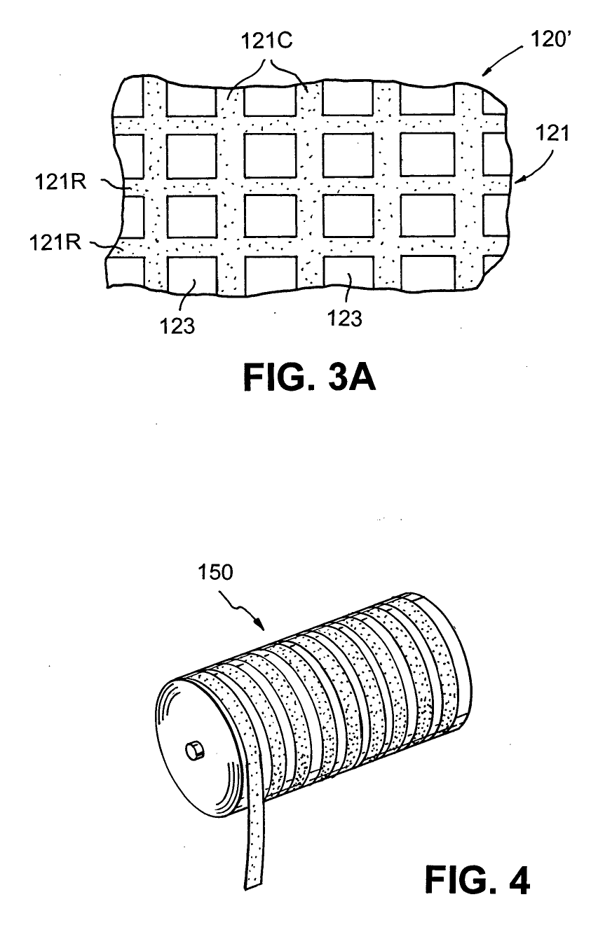

The plasma display includes a first set of conductors 122 that are disposed in the y-direction above the surface of the first substrate 120. illustrated in FIG. 4, the conductors comprise ferromagnetic strips on a roll 150 for dispensing from the roll 150 and placement onto the substrate 120. More preferably, the conductors 122 are applied to the insulating layer 124 by a silk screening process. As illustrated, the first set of conductors 122 is fixed to the surface of the substrate 120 by the magnetic attraction between the substrate 120 and the first set of conductors 122. a magnetic bond eliminates the need to secure the conductors with fasteners, chemicals, adhesives, etching or other component or manufacturing step.

A second set of conductors 128 disposed in the x-direction define rows which cross over the first set of conductors 122 to define the array of crosspoints 130. crosspoint 130 and associated cavity 126 forms a plasma emitter 112 (FIG. 2), the operation of which is discussed below. The second set of conductors 128 can be the same material as the first set of conductors 122 and both sets of conductors can embody magnetic or ferromagnetic magnetic properties for bonding and/or self-alignment with the substrate. The second set of conductors 128 are disposed at a preselected distance from the first set of conductors 122 (as defined by the spacers or projections 127) and at an angle thereto, preferably a perpendicular angle to define the cavity 126.

The substrate can be provided with a continuous, generally planar layer of magnetic or ferromagnetic material (“M/FM material”), in which case the conductors are magnetically bonded when brought into contact with the insulating layer 124. Consequently, the conductors must first be brought into alignment so that they are affixed in their intended position (e.g., by a guide associated with the roller 150).

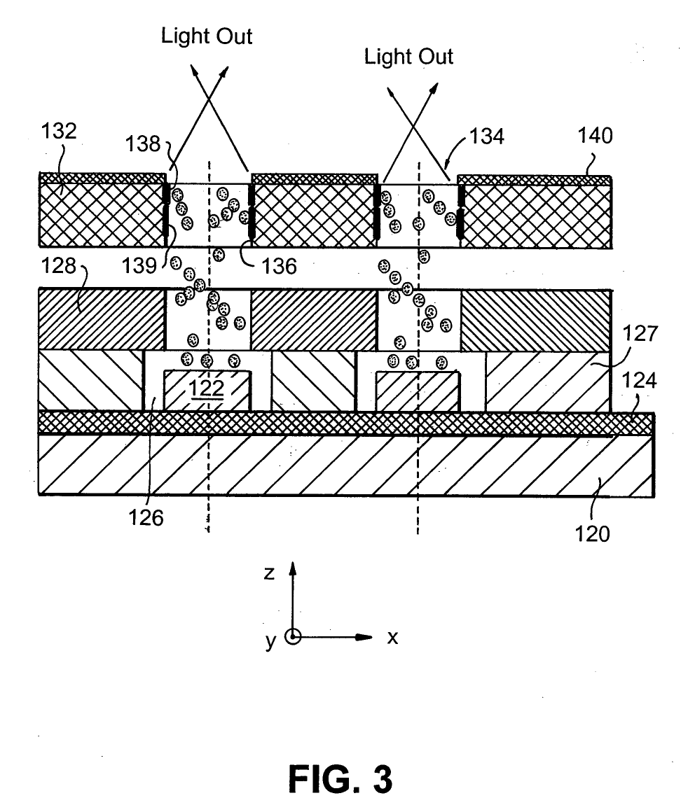

In an alternative arrangement as shown in FIG. 3a, the substrate 120″ has the M/FM material 121 arranged in a pattern such that rows 121R intersect with columns 121C at locations below the crosspoints 130 (at which the conductors 122, 128 will cross once affixed to the substrate). In this arrangement, the conductors can be magnetically bonded when brought into contact with the insulating layer 124, and also can be self-aligned relative to one another by directed attraction of the patterned M/FM material. In this arrangement, regions 123 of the substrate 120 are free of any M/FM material.

The preselected distance between the sets of conductors defines the discharge space for the gas and is accomplished through the use of projections 127 disposed between the substrate 120 and the second set of conductors 128. For example, the projections 127 can be integral with the conductors 128 and can be formed by a coining process. Alternatively, the projections can be integral with the conductors 128 and formed by some other process such as electroforming. In FIG. 3, the projection rests on the porcelain enamel layer 124 in areas clear of crosspoint 130.

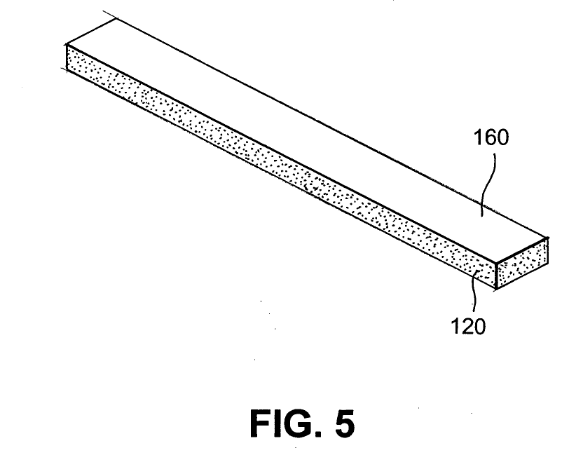

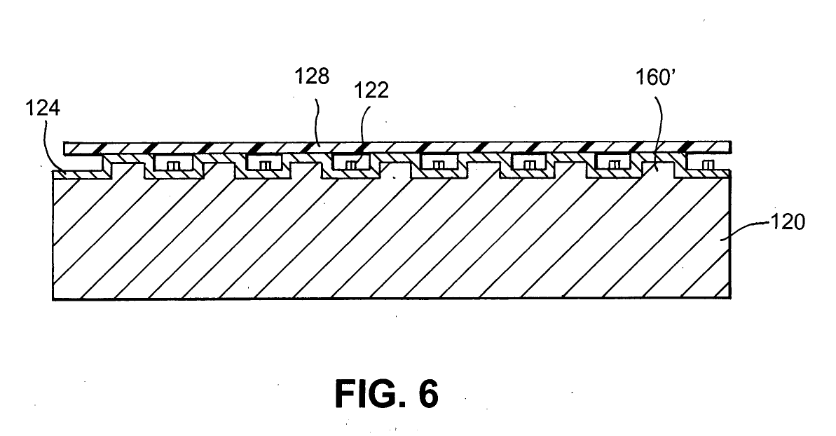

As shown in FIG. 6, the projections 127 are preferably integrally formed with the first substrate 120 and are of uniform height so that the distance between the sets of conductors 122 and 128 is constant throughout the display 110. The height of the projections is chosen so that light emissive discharge initiates within the cavity associated with a particular crosspoint only when a voltage greater than or equal to the Paschen minimum firing voltage is applied across the conductors at said particular crosspoint. A height of about 1 micron for the projections is preferred for small displays and a height of about 10 microns for the projections of large displays that are essentially at atmospheric pressure. The integral projections can comprise protuberances 160 as shown in FIG. 5, or elongated supports in the y-direction as illustrated in FIG. 6.

Referring to FIG. 6, the first set of conductors 122 is supported by the porcelain-enamel coated surface of the substrate 120 at locations where the supports 160″ are not present and the second set of conductors 128 are disposed on the porcelain-enamel coated supports, thereby establishing the preselected distance between the sets of conductors 122 and 128. Since the substrate 120 and the first set of conductors are each composed of magnetic or ferromagnetic materials, the second set of conductors 128 affixes itself to the supports 160″ as a result of the magnetic bond therebetween, and so the second set of conductors can be joined to the substrate 120 without additional processing. Alternatively, grooves can be etched into the substrate 120 and the first set of conductors 122 can be disposed within the grooves while the second set of conductors 128 can be disposed above the grooves in a crossing (anti-parallel) direction. Also alternatively, the projections may be integral with the second set of conductors 128 and introduced to the plasma display 110 construction upon magnetically bonding the conductors 128 to the substrate 120.

Preferably, the insulating layer 124 covers the protuberances or supports 160, 160′.

An array of plasma emitters 112 may be formed having other configurations, as will be apparent to one skilled in the art. skilled in the art will also recognize that conductors 122 and 128 need not be linear strips of conductive material as shown, but may be crossed sinusoids, square or triangular wave patterns or the like.

As used herein, a cavity 126 is defined as an open region between or adjacent a plurality of conductors within which, when the cavity contains a gas, a plasma discharge can occur upon application of a sufficient voltage to the conductors. Several cavities 126 can exist within a single open region extending across several diffused conductors.

The effectiveness of the discharge cavity 126 can be improved by adding a second anode positioned so as to draw the plasma emission in a desired direction. FIG. 3 shows that arrangement.

Referring again to FIG. 3, a second substrate 132 has an array of tubes 134 formed in it which are in register with the array of plasma emitters 112 (at the crosspoints 130 above the cavities 126). hollow tubes 134 are substantially longer than they are wide and define axial walls, an upper end and a lower end. lower end is substantially open and disposed next to the first substrate 120 to receive the plasma. The hollow tubes 134 further include a terminating wall at their upper end that includes an electrically conductive layer. Because the second substrate 132 is positioned relative to the first substrate 120 such that the array of hollow tubes 134 are in register with the discharge cavities 126, an array of substantially hollow chambers is defined by the cavities 126 between the sets of conductors 122 and 128 and the hollow tubes 134. the preferred embodiment, the tubes have a substantially rectangular cross-section; however, the cross-section of the hollow tubes 134 may be of any shape and its shape may vary along the length of the tubes 134.

The second substrate (superstrate) 132 is comprised of a material such as silicon or PYREX AE glass. Substrate (superstrate) 132 is processed to form an array of tubes 134 therein and spaced so that one or more tubes in the array corresponds to the locations of the crosspoints 130. Tubes 134 may be formed in substrate 132 by conventional pattern techniques combined with anisotropic etching, reactive ion etching or water etching and are preferably longer in the Z direction than they are wide (in the x- and y-directions). In the water etching (or honing) process, a very narrow stream of water containing an abrasive material is projected at high velocity through an overlay mask onto the substrate 132. An advantage of this technique is that it is highly directional and provides an aspect ratio of tube length versus diameter of as great as about 50:1. For example, tubes 134 may be formed in substrate 132 which are 100 microns long or deep and only about 10 microns wide over the entire length of the tube. In a preferred embodiment, substrate 132 is greater than 100 microns thick and the tubes 134 penetrate substrate 132 completely. One end of the tubes 134 is sealed by a coverplate 140, discussed below. The tubes can be tapered to be wider at the top than the bottom. Tapering the tubes allows reflected light to propagate upwards and thereby facilitates light escaping from the tube through the coverplate.

A phosphor layer 138 is deposited on the axial walls 136 of the hollow tubes 134. phosphor layer 139 is formed with a grain structure having a grain size selected to prevent lateral transmission (“trapping”) of light within the layer 138. Preferably, a reflecting layer 139 is disposed on the axial walls 136 beneath the phosphor layer 138 (e.g., a layer comprising vacuum deposited silver). Preferably, prior to applying the phosphor 38, the walls 36 of the tubes are “silvered” by depositing a highly reflective coating 139 of a material such as silver or aluminum to increase light reflectance. The combination of silvering and tapering of the tubes greatly increases the amount of light which escapes through the cover plate to be viewed by the observer, and thus increases display efficiency.

The tubes 134 are sealed at their upper ends with a transparent cover plate 140 which is preferably conductive so as to serve as a second anode for drawings the plasma upward, through the chambers 134 and beyond the cavities 126. preferred material for cover plate 140 is PYREX coated with indium tin oxide because of this coating's known transparency in the visible spectrum and electrical conductivity.

The array of tubes 134 is aligned with the crosspoints 130 on the substrate 120, and the second substrate (superstrate) 132 is bonded along its edges to the first substrate 120 with e.g., a metal ring or glass bead 50. Alternatively, substrate (superstrate) 132 is bonded to first substrate 120 prior to the formation of tubes 134. The two substrates can be aligned with a precision, for example, on the order of a few microns tolerance. It can be appreciated that if the size of the plasma emitters 112 are large compared with the cross-section of the tubes 134, alignment is less critical as many tubes 134 will be in register with each cavity 126 of the plasma emitter so long as the array of tubes 134 is positioned over the array of plasma emitters.

The chambers contain a gas suitable for producing a plasma discharge, such as Argon, Nitrogen or Neon with the addition of 5% Xenon. The gas is preferably at or above 0.8 atmosphere, and more preferably essentially at one atmosphere, as previously taught by Lepselter. Although a high pressure gas will exert a force on the cover plate 140 and the structures adjacent cavities 126 and tubes 134, the overall force exerted is minimal because of the very small area-to-perimeter ratio if one is building a very small area display.

The structure is filled with a pressurized gas such as Nitrogen, Argon or Neon with 5% Xenon and sealed by a transparent, conducting coverplate 140 which forms a terminating wall for the tubes 134. Preferably, coverplate 140 is glass coated with tin oxide and its derivatives, such as indium tin oxide (ITO). Derivatives of tin oxide, as used herein, are meant to embrace at least the family of ternary compounds which include an element plus tin and oxygen, as well as compounds containing more than three elements. The pertinent virtue of tin oxide and some of its derivatives is that they are transparent and electrically conductive. Those skilled in the art will recognize that the tubes may also be formed so that the coverplate is integral with the second substrate.

When a voltage difference above the minimum Paschen firing voltage, Vmin, is applied to a plasma emitter 112 formed by crossed conductors 122 and 128 and cavity 126, the gas in the cavity 126 at that selected crosspoint 130 breaks down into a plasma of charged particles 141 at Vmin will occur between a point on conductor 122 and a point on conductor 128 which are at distance d apart, in accordance with Paschen's law discussed above. may be many possible locations within each crosspoint at the proper distance d and the overlapping nature of the crossed conductors 122 and 128 allows for a range of possible distances d depending on the discharge path between the conductors. example, a direct path may have a distance d₁, whereas a diagonal path provides a longer distance d₂. operation, the system will find the discharge path best suited to the actual gas pressure and applied voltage.

Applying an appropriate voltage to the conducting layer on the cover plate 140 causes the plate 140 to function as a virtual cathode (or anode, depending on the voltage polarity) which draws plasma created by the plasma display element from the cavity 126 into the tube 134. The electrons in the plasma gas drop in energy from their excited states to a lower energy level; this process produces light, which for many gases occurs in the ultraviolet range of the electromagnetic spectrum. The ultraviolet discharge in the tube 134 interacts with the phosphor 138 on the walls 136 of the tube 134 to produce visible light which can be seen through the transparent cover plate 140. the assembly is made with tubes 134 that have heights significantly greater then their respective diameters, the structure at each crosspoint 130 provides, in effect, an integrated array of fluorescent light bulbs.

The array of plasma emitters 112 and associated tubes 134, in conjunction with appropriate support circuitry, comprises a plasma display 110. color display is provided by grouping the pixels into triads, where each triad has three elements with different phosphors 138 to generate the red, green, and blue primary colors. Alternately, a white phosphor can be used and appropriate color filters can be formed on coverplate 140, in register with the plasma emitters 112.

Using a vertical tube structure over each cavity 126 provides multiplication of the surface area on which phosphor may be deposited, greatly increasing the display efficiency as compared with pure planar displays, without increasing the amount of area required by the display on the silicon substrate. example, a planar display with a discharge cavity 126 of length w and width w and negligible height has a surface area of w² on which phosphor may be applied. tube with a square cross-section of the same size as the cavity 26 but having a height h provides a vertical surface area equal to 4*h*w.

The ratio between the two- and three-dimensional structure, 4*h/w is a measure of the degree to which this area multiplier improves display efficiency. h is larger than w, a large area multiplication is achieved with a single tube. example, where w is 10 microns and h is 100 microns, the phosphor area, and thus the display efficiency, is increased by a factor of 40. w is larger than h, area multiplication is achieved by providing many tubes for each discharge region. example, a width w of 10 Âμm gives a planar surface area of 100 Âμm². a height h of 5 Âμm, an array of 100 tubes with a width of 0.5 Âμm (a 10×10 array) gives a total area of 4*5 Âμm*0.5 Âμm*100=1000 Âμm, an improvement by a factor of ten.

Although the preferred embodiment comprises plasma emitters formed by an array of crosspoints 130 and cavities 126, the present invention is not limited to this particular arrangement and those skilled in the art will recognize that the vertical tube structure described above may be coupled with an array of plasma emitters of any particular conductor configuration. The area multiplier can also be easily adapted for use with arrays of other types of light-emitting display elements where the increased phosphor area will enhance the output of the display.

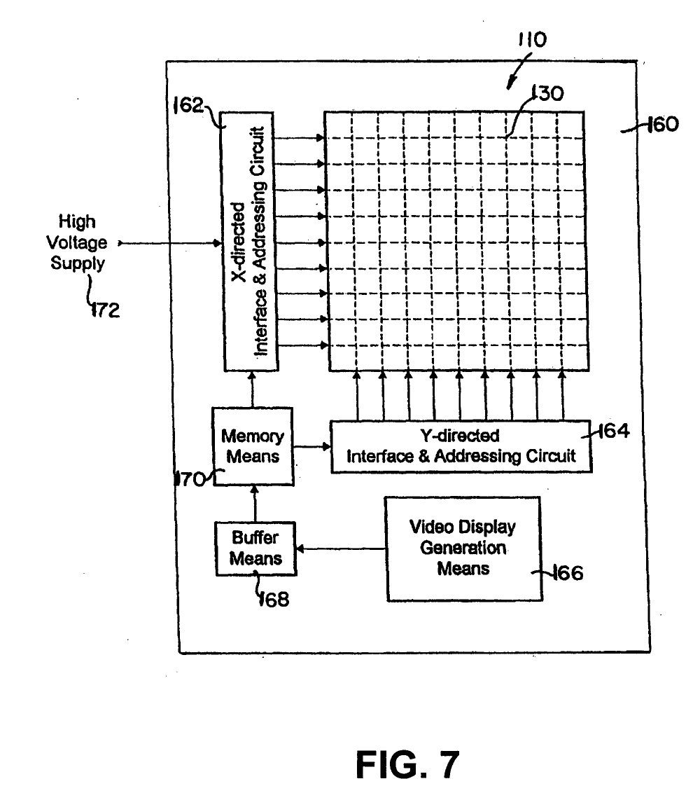

FIG. 7 is an illustration of an integrated circuit 160 incorporating a plasma display 110. display 110 is driven by x- and y-directed interface and addressing circuits 162, 164. image to be displayed is generated by the video display generation means 166. The image is preferably represented by a digitized array of pixels, advantageously addressable by row and column coordinates corresponding to like coordinates of the crosspoints 130 forming the plasma emitters in the display 110. buffer 168 stores the addressable image data in conventional manner, by row and column coordinates. stored image data may comprise status, intensity, and color level information. memory 170 may receive one image frame from the buffer 168 so that the next image may be loaded into the buffer 168.

In operation, the pixels of display 110 are addressed or scanned sequentially, a row at a time, by interface and addressing circuits 162, 164. A voltage from high voltage supply 172 is selectively applied to crosspoints 130 in accordance with the status and intensity information associated with each pixel of a given image frame. interface and addressing circuits 162, 164 scan the display 110 at least 60 times per second so that a human eye may perceive a steady image.

The plasma display 110, according to the invention, overcomes a significant and limiting factor of the achievable resolution of conventional display technology. pixel density for miniature displays must be high enough to supply acceptable resolution when the display area is enlarged for viewing. an example, a conventional high resolution fax image has a pixel density of 180 dpi. contrast, the best computer monitors have a resolution of about 90 dpi.) standard 8.5 inch fax with one inch margins thus has approximately 1,200 pixels per line.

While the invention has been particularly shown and described with reference to preferred embodiments thereof, it will be understood by those skilled in the art that various changes in form and details may be made therein without departing from the spirit and scope of the invention.

1. A plasma display comprising:
a first substrate having a surface and including a material selected from the group of magnetic materials and ferromagnetic materials;
a first set of conductors disposed proximate the first substrate;
a second set of conductors disposed a preselected distance from the first set of conductors and at an angle to the first set of conductors, the second set of conductors crossing over the first set of conductors to form an array of crosspoints;
a projection disposed between the first substrate and the second set of conductors to establish the preselected distance defining a discharge space; and
an insulating layer disposed between the first set of conductors and the surface of the first substrate.

2. The plasma display of claim 1, wherein the insulating layer abuts at least a portion of both of the first and second sets of conductors.

3. The plasma display of claim 1, wherein the insulating layer abuts at least one of the first and second sets of conductors.

4. The plasma display of claim 1, wherein the insulating layer comprises a porcelain enamel coating on the surface of the first substrate.

5. The plasma display of claim 1, wherein the projection is integral with the first substrate.

6. The plasma display of claim 5, wherein the projection is a protuberance formed on the surface of the first substrate.

7. The plasma display of claim 5, wherein the projection is a feature deposited on the surface of the first substrate.

8. The plasma display of claim 1, wherein the projection is associated with the second set of conductors.

9. The plasma display of claim 1, further including a second substrate having a plurality of hollow tubes therein, the hollow tubes being substantially longer than they are wide.

10. The plasma display of claim 9, wherein each said hollow tube has an upper end and a lower end, is open on the lower end, has axial walls and has a terminating wall at the upper end, said terminating wall including an electrically conductive layer.

11. The plasma display of claim 10, wherein the second substrate abuts the first substrate so that the lower ends of the hollow tubes are in register with the crosspoints to thereby define an array of chambers comprising the hollow tubes and the preselected distance between the sets of conductors.

12. The plasma display of claim 11, wherein the hollow chambers are filled with a gas.

13. The plasma display of claim 9, wherein the lower end of the hollow tube has a diameter that is smaller than a diameter of the upper end of the hollow tube.

14. The plasma display of claim 9, wherein the axial wall of the hollow tube includes a phosphor coating.

15. The plasma display of claim 9, wherein the second substrate is transparent and is bonded to one of the first substrate and the array of microbridges.

16. The plasma display of claim 1, wherein said preselected distance is chosen so that light emissive discharge initiates within the crosspoint only when a voltage greater than or equal to the Paschen minimum firing voltage is applied across the conductors at the particular crosspoint.

17. The plasma display of claim 12, wherein the gas comprises at least one of Argon, Neon, and Xenon.

18. The plasma display of claim 12, wherein the gas is at a pressure of about ten atmospheres and the preselected distance is about one micrometer.

19. The plasma display of claim 12, wherein the gas is at a pressure of at least about 0.8 atmospheres.

20. The plasma display of claim 14, further comprising a reflective layer disposed on the axial walls of the tubes and a phosphor layer disposed on the reflective layer.

21. A plasma display comprising:
a first substrate having a surface and including a material selected from the group of magnetic materials and ferromagnetic materials;
a first set of conductors disposed on the surface of the first substrate;
a second set of conductors disposed a preselected distance from the first set of conductors and at an angle to the first set of conductors, the second set of conductors crossing over the first set of conductors to form an array of crosspoints;
a projection integral with the first substrate and positioned between the first substrate and the second set of conductors to establish the preselected distance defining a discharge space; and
a porcelain enamel coating disposed on the surface of the first substrate.
